(19) United States
(12) Patent Application Publication
(10) Pub. No.: US 2010/0108174 A1
(43) Pub. Date: May 6, 2010

(54) SCREW THREAD SAFEGUARD OF DRILL STEMS

(76) Inventor: Shijun Qiao, Jiangsu Province (CN)

Correspondence Address: J. Elliot Alfred;Craft Chu PLLC, 1445 N. Loop W., Suite 840, Houston, TX, 77008, US

(21) Appl. No.: 12/299,458

(22) PCT Filed: Jan. 8, 2008
(86) PCT No.: PCT/CN2008/000058

§ 371 Date: Dec. 14, 2009

(30) Foreign Application Priority Data
Aug. 3, 2007 (CN) 200720127975.6

(51) Int. Cl. E21B 17/10; F16L 57/00; F16L 15/04

(52) U.S. Cl. 138/96 T

(57) ABSTRACT

The present utility model relates to the field of drill stem safeguard. Specifically, the present utility model relates to a kind of screw thread safeguard of drill stem. In order to overcome the disadvantages of the modern drill stem safeguard that it is difficult to be installed or disassembled and falls off easily, its house may separate from the plastic component, and the screw thread of the drill stem may be damnified easily. the object of the utility model is to provide a screw thread safeguard of the drill stem, which comprises an inner loop and an outer loop. The detailed structure is stated in the description. The screw thread safeguard of the drill stem in the present utility model can be installed and disassembled simply. And it doesn't fall off generally. Its house will not separate from the plastic component easily, and it can protect the screw thread from damnification.

### TECHNICAL FIELD

The present utility model relates to the field of the drill stem safeguard. Specifically, the present utility model relates to a kind of screw thread safeguard of the drill stem.

### BACKGROUND ART

During boring a well, the drill stem has to be jointed before used. If the screw thread of the drill stem is damnified, the phenomena, such as thread tripping, thread adhesion and so on, may happen and lead to bad airproof capability and bad connection intensity. Worsely, the boring tools may be punctured and discarded as useless, and even the malignant accident may occur. So, when the drill stems are produced, transported and stored, the screw thread should be protected carefully from damnification.

The drill stem safeguard in prior art has various disadvantages. They are as follows: there is no handling hole, or there is a square handling hole on the surface of the iron house, which is at an angle of 90 degrees with the screw thread of the safeguard. A special spanner must be used to match the hole. The hole is too small and its direction is at an angle of 90 degrees with the screw thread, so when the safeguard is assembled and disassembled, it may slide easily and damnify the special spanner and the square hole, because of the great torque, which will cause that the safeguard cannot connect well with the screw thread or cannot be disassembled from it; There is no orifice to connect the handling hole and the plastic component on the iron house. Therefore the iron house often separates from the plastic component during assembling and disassembling process; Forces act on the drill stem in the slope direction frequently during the transport, assembling and disassembling process. Therefore, the section of the screw thread is the most vulnerable. The buffer space of the prior art product is so small that the protection of the screw thread is not very effective. Water and caustic matters may enter into the safeguard, damnify the screw thread of the drill stem and cause the rustiness easily. During the assemblage process, the safeguard may not be rotated to the bottom because there is no place to store too much thread dope. Therefore the safeguard may fall off for the shake during the transport process.

### BRIEF SUMMARY OF THE UTILITY MODEL

In order to overcome the disadvantages of the prior drill stem safeguard that it is difficult to be installed or disassembled and falls off easily, its house may separate from the plastic component, and the screw thread of the drill stem may be damnified easily. the object of the utility model is to provide a screw thread safeguard of the drill stem, which can be installed and disassembled simply. And it doesn't fall off generally. Its house will not separate from the plastic component easily, and it can protect the screw thread from damage.

In order to solve the technic problems, the technic programme that the present utility model adopts is as follows: A screw thread safeguard of a drill stem comprises an outer loop connected with said drill stem by nesting. And said outer loop includes a house for counteracting impact, a buffering plastic component, a cover board, a buffer space, a storage for thread dope, a seal, a handling hole, a bulge for stopping rotation and a screw thread. Wherein said handling hole is located on the exterior brim of the coping of the house for counteracting impact. The central section of said house for counteracting impact tightly joints and connects with the center section of said buffering plastic component by means of nesting. Said bulge for stopping rotation is located on the joint part of said house for counteracting impact and said buffering plastic component. Said buffer space is located between the coping of said house for counteracting impact and the coping of said plastic component. The interior diameter of said buffering plastic component can even match said drill stem. Said buffering plastic component is provided with a screw thread to connect with the screw thread of said drill stem. Said seal is located on the joint part between the upper and the nether ends of the inner of said buffering plastic component and the drill stem. And said storage for thread dope is located on the upper and the nether ends of the joint part between the inner of said buffering plastic component and said drill stem.

The screw thread safeguard also comprises an air hole, which is located on the coping of the house for counteracting impact.

The screw thread safeguard also comprises a label hole, which is located on the coping of the house for counteracting impact.

A screw thread safeguard of a drill stem comprises an inner loop connected with said drill stem by nesting. And said inner loop includes a house for counteracting impact, a buffering plastic component, a buffer space, a storage for thread dope, a seal, a handling hole, a bulge for stopping rotation and a screw thread. Wherein said handling hole is located on the exterior brim of the coping of said house for counteracting impact. The nether sections of said house for counteracting impact tightly joints and connects with the center section of said buffering plastic component by means of nesting. Said bulge for stopping rotation is located on the joint part of said house for counteracting impact and said buffering plastic component. Said buffer space is located on the coping of said buffering plastic component. The outside diameter of said buffering plastic component can even match said drill stem. Said buffering plastic component is provided with a screw thread to connect with the screw thread of said drill stem. Said seal is located on the joint part between the upper and the nether ends of the outside of said buffering plastic component and said drill stem. And said storage for thread dope is located on the upper and the nether ends of the joint part between the outside of said buffering plastic component and said drill stem.

There are four handling holes.

The handling holes have inerratic shape, such as circular holes, hexagonal holes and so on. The circular hole is preferred.

The storage for thread dope is a small interspace which is located between the buffering plastic component and the drill stem.

The bulge for stopping rotation is a bulge on the joint part of the house for counteracting impact and the buffering plastic component, which is inserted in the buffering plastic component. The bulge is made by die stamping, which is formed by breaking a gap in the iron house and blocking on the plastic core.

During the operation, drill stems are used through the connection of the screw thread. Therefore a drill stem usually has an inner screw thread in one end and an outer screw thread in the other end. The outer diameter of outer screw thread is even equal to the interior diameter of the inner screw thread, and then two dill stems can connect tightly through the screw thread. So the present utility model also has an inner loop and an outer loop, which are used together. They are set at the two ends of the drill stem to protect the screw thread. The two parts of the present utility model have the same design idea and the same outline, and they are matched to be used together.

Compared with the prior art, the benefits of the present utility model are as follows:

1. Handling hole. The prior art product has no handling hole or has a square handling hole on the end surface of the iron house, which is at an angle of 90 degrees with the screw thread of the safeguard. A special spanner must be used to match the hole. The hole is too small and its direction is at an angle of 90 degrees with the screw thread, so when the safeguard is assembled and disassembled, it may slide easily and damnify the special spanner and the square hole, because of the great torque, which will cause that the safeguard cannot connect well with the screw thread or cannot be disassembled from it. There is no orifice to connect the handling hole and the plastic component on the iron house and therefore the iron house often separates from the plastic component during assembling and disassembling process. The present utility model has more than two orifices on the exterior brim of the coping, whose diameter is more than ¢ 10.5 mm. The direction of the force and the direction of the screw thread of the safeguard are uniform. The handling holes are circular orifices, so the special tools are unnecessary, and iron sticks with qualified intensity can be used for assembling and disassembling without slide, such as a screwdriver and a columnar iron pole. The handling holes in the iron house and the plastic component are concentric orifices, so the iron house will not separate from the plastic component when assembled and disassembled.

2. Buffering space. Forces act on the drill stem in the slope direction frequently during the transport and assembling and disassembling process. Therefore the section of the screw thread is the most vulnerable. The buffer space of the prior art product is so small that the protection of the screw thread is not very effective. The present utility model product has lager buffering room. Even though the iron house of the safeguard is distorted by forces, the screw thread will not be affected greatly.

3. Bulge for stopping rotation. The prior art product has no bulge for stopping rotation. The present utility model product has more than four bulges for stopping rotation. Based on the interference fit of the iron house and the plastic component, the plastic core and the iron house are made together by die stamping, which is formed by breaking a gap in the iron house and blocking on the plastic core. They will not separate during assembling and disassembling the safeguard.

4. The chamfer in transition section of pipe and screw thread of the drill stem is covered. There is no chamfer coverage in the prior art product, and it rusts easily. The chamfer in the present utility model product is covered totally. The two ends of the two drill stems will not be damnified, and their connection surface is sealed well.

5. Storage for thread dope. The prior art product has no such component.

During the assemblage process, the safeguard may not be rotated to the bottom because too much thread dope has no place to store. Therefore the safeguard may fall off for the shake during the transport process. The present utility model product sets a store room for thread dope, which will make the safeguard and the drill stem match tightly without slide.

6. The safeguard has no metallic contact with the sensitive area of the pipe. The complete steel safeguard of the prior art product will rust and adhere to the screw thread of the drill stem under the condition of long-playing storing. And the outside forces acting no the safeguard will be transferred to the screw thread of the drill stem and distort it, which may affect the connection of the male thread and female thread, seal property, the connection intension and so on. The safeguard with outer loop in the present utility model product is steel-outside and plastic-inside, whereas the safeguard with an inner loop is steel-inside and plastic-outside. The steel house and the plastic component adopt the interference fit. And the safeguard has no metallic contact with the sensitive area of the pipe. Under the outside forces, the steel house bears the forces and the plastic component absorbs shock.

7. The effective seal on the main brims. There is no seal on the main brim in the prior art product. The safeguard of the present utility model product sets effective seals on the main brims. When the drill stem with screw thread is rotated into the safeguard, the seals will insulate the screw thread of the drill stem to prevent water and caustic matters from entering and damnifying the screw thread.

### DESCRIPTION OF THE SEVERAL VIEWS OF THE DRAWINGS

FIG. 1 is a schematic illustration of the structure of the screw thread safeguard with an inner loop of the drill stem according to the present utility model.

FIG. 2 is a schematic illustration of the structure of the screw thread safeguard with an outer loop of the drill stem according to the present utility model.

### DETAILED DESCRIPTION OF THE INVENTION

Details of the present utility model are illuminated combining with the figures and embodiments, which will not limit the utility model.

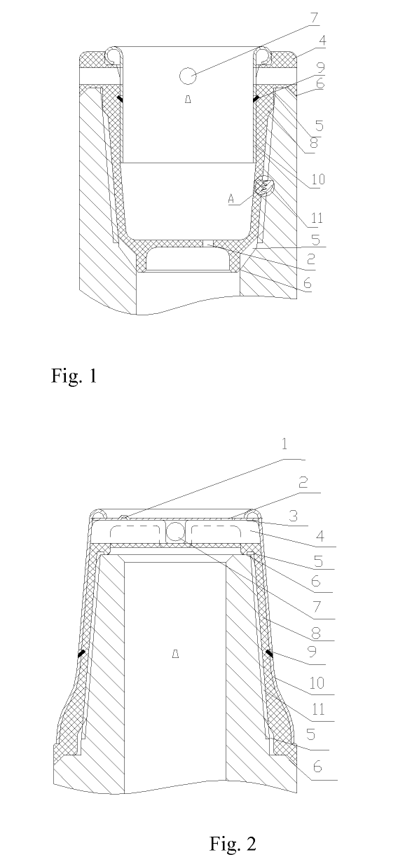

Please refer the embodiments of the screw thread safeguard of the drill stem according to the present utility model shown in FIG. 1 and FIG. 2.

### Embodiment 1

A screw thread safeguard of a drill stem comprises an outer loop connected with said drill stem by nesting. And said outer loop including a house for counteracting impact 10; a buffering plastic component 8; a cover board 3; a buffer space 4; a storage for thread dope 5; a seal 6; a handling hole 7; a bulge for stopping rotation 9 and a screw thread 11. The said handling hole 7 is located on the exterior brim of the coping of the house for counteracting impact 10. The central section of said house for counteracting impact 10 tightly joints and connects with the center section of said buffering plastic component 8 by means of nesting. Said bulge for stopping rotation 9 is located on the joint part of said house for counteracting impact 10 and said buffering plastic component 8. Said buffer space 4 is located between the coping of said house for counteracting impact 10 and the coping of said plastic component 8. The interior diameter of said buffering plastic component 8 can even match said drill stem. Said buffering plastic component 8 is provided with a screw thread to connect with the screw thread of said drill stem. Said seal 6 is located on the joint part between the upper and the nether ends of the inner of said buffering plastic component 8 and the drill stem. And said storage for thread dope 5 is located 8 on the upper and the nether ends of the joint part between the inner of said buffering plastic component 8 and said drill stem.

The screw thread safeguard also comprises an air hole 2, which is located on the coping of the house for counteracting impact 10.

The screw thread safeguard also comprises a label hole 1, which is located on the coping of the house for counteracting impact 10.

There are four handling holes 7.

The storage for thread dope 5 is a small interspace which lies between the buffering plastic component 8 and the drill stem.

The bulge for stopping rotation 9 is a bulge on the connection part of the house for counteracting impact 10 and the buffering plastic component 8, which is inserted in the buffering plastic component 8. It is made by die stamping, which is formed by breaking a gap in the iron house and blocking on the plastic core. The outer loop can be nested either inside or outside the drill stem. It is always used for protecting the inner screw thread.

### Embodiment 2

A screw thread safeguard of a drill stem comprises an inner loop connected with said drill stem by nesting. And said inner loop including a house for counteracting impact 10, a buffering plastic component 8, a buffer space 4, a storage for thread dope 5, a seal 6, a handling hole 7, a bulge for stopping rotation 9 and a screw thread 11. wherein said handling hole 7 is located on the exterior brim of the coping of said house for counteracting impact 10. The nether sections of said house for counteracting impact 10 tightly joints and connects with the center section of said buffering plastic component 8 by means of nesting. Said bulge for stopping rotation 9 is located on the joint part of said house for counteracting impact 10 and said buffering plastic component 8. Said buffer space 4 is located on the coping of said buffering plastic component 8. The outside diameter of said buffering plastic component 8 can even matches said drill stem. Said buffering plastic component 8 is provided with a screw thread 11 to connect with the screw thread of said drill stem. Said seal 6 is located on the joint part between the upper and the nether ends of the outside of said buffering plastic component 8 and said drill stem. And said storage for thread dope 5 is located on the upper and the nether ends of the joint part between the outside of said buffering plastic component 8 and said drill stem.

There are four handling holes 7.

The handling holes 7 have inerratic shape, such as circular holes, hexagonal holes and so on. The circular hole is preferred.

The storage for thread dope 5 is a small interspace which lies between the buffering plastic component 8 and the drill stem.

The bulge for stopping rotation 9 is a bulge on the connection part of the house for counteracting impact 10 and the buffering plastic component 8, which is inserted in the buffering plastic component 8. It is made by die stamping, which is formed by breaking a gap in the iron house and blocking on the plastic core. The inner loop can be nested either inside or outside the drill stem. It is always used for protecting the outer screw thread. The inner loop and the outer loop can be used assortatively or be used respectively.

The foregoing embodiment is just one of the preferred ones. Various changes and displacements can be made within the scope of the present utility model without departing from the true spirit of the utility model.

1. A screw thread safeguard of a drill stem comprises an outer loop connected with said drill stem by nesting, and said outer loop including a house for counteracting impact; a buffering plastic component; a cover board; a buffer space; a storage for thread dope; a seal; a handling hole; a bulge for stopping rotation and a screw thread; wherein said handling hole lying on the exterior brim of the coping of the house for counteracting impact; the central section of said house for counteracting impact tightly jointing and connecting with the center section of said buffering plastic component by means of nesting; said bulge for stopping rotation lying on the joint part of said house for counteracting impact and said buffering plastic component; said buffer space lying between the coping of said house for counteracting impact and the coping of said plastic component; the interior diameter of said buffering plastic component even matching said drill stem; said buffering plastic component being provided with a screw thread to connect with the screw thread of said drill stem; said seal lying on the joint part between the upper and the nether ends of the inner of said buffering plastic component and the drill stem; and said storage for thread dope lying on the upper and the nether ends of the joint part between the inner of said buffering plastic component and said drill stem.

2. The screw thread safeguard of claim 1, wherein it comprises an air hole, which is located on the coping of the house for counteracting impact.

3. The screw thread safeguard of claim 1, wherein it comprises a label hole, which is located on the coping of the house for counteracting impact.

4. The screw thread safeguard of claim 1, it comprises four handling holes.

5. The screw thread safeguard of claim 1, wherein said handling holes are circular holes.

6. The screw thread safeguard of claim 1, wherein said bulge for stopping rotation is a bulge on the connection part of the house for counteracting impact and the buffering plastic component, and it is inserted in the buffering plastic component.

7. A screw thread safeguard of a drill stem comprises an inner loop connected with said drill stem by nesting, and said inner loop including a house for counteracting impact, a buffering plastic component, a buffer space, a storage for thread dope, a seal, a handling hole, a bulge for stopping rotation and a screw thread; wherein said handling hole lying on the exterior brim of the coping of said house for counteracting impact; the nether sections of said house for counteracting impact tightly jointing and connecting with the center section of said buffering plastic component by means of nesting; said bulge for stopping rotation lying on the joint part of said house for counteracting impact and said buffering plastic component; said buffer space lying on the coping of said buffering plastic component; the outside diameter of said buffering plastic component even matching said drill stem; said buffering plastic component being provided with a screw thread to connect with the screw thread of said drill stem; said seal lying on the joint part between the upper and the nether ends of the outside of said buffering plastic component and said drill stem; and said storage for thread dope lying on the upper and the nether ends of the joint part between the outside of said buffering plastic component and said drill stem.

8. The screw thread safeguard of claim 7, wherein it comprises four handling holes.

9. The screw thread safeguard of claim 7, wherein said handling holes are circular holes.

10. The screw thread safeguard of claim 7, wherein said bulge for stopping rotation is a bulge on the connection part of said house for counteracting impact and said buffering plastic component and it is inserted in said buffering plastic component.
